(19) United States
(12) Patent Application Publication
(10) Pub. No.: US 2008/0290184 A1
(43) Pub. Date: Nov. 27, 2008

(54) Heating Insert

(76) Inventors: Jurgen Stritzinger, Freckenfeld (DE); Oleg Kexel, Ettlingen (DE); Roland Starck, Bellheim (DE); Armin Lang, Barbelroth (DE); Ingo Ragaller, Muhlheim (DE)

Correspondence Address: WALTER A. HACKLER, Ph.D.;PATENT LAW OFFICE, 1372 S.E. BRISTOL STREET, SUITE B, NEWPORT BEACH, CA, 92660-0755, US

(21) Appl. No.: 12/154,614

(22) Filed: May 23, 2008

(30) Foreign Application Priority Data
May 26, 2007 (DE) 10 2007 024 782.8

(51) Int. Cl. B60H 1/00

(52) U.S. Cl. 237/12.3 C

(57) ABSTRACT

The invention relates to a heating element for thawing a fluid comprising at least one heating element, which is arranged in a housing (20), an intake pipe (21) made of plastic, which is fastened to the housing (20) for dipping into the fluid, at least one electrical connecting line (22, 23), which emanates from the housing (20) and which runs along the intake pipe (21). Provision is made according to the invention for the intake pipe (21) to support the at least one connecting line (22, 23).

The invention relates to a heating insert comprising the features specified in the preamble of claim 1. Such heating inserts are required for urea supply systems, for example, which are usually installed in motor vehicles for supplying an exhaust gas cleaning catalyst comprising reducing agents. The invention furthermore relates to a urea supply system comprising the features specified in the preamble of claim 21, which includes such a heating insert. Such a heating insert and such a urea supply system are known from WO 2006/131201.

Exhaust gas cleaning catalysts require urea as a source of ammonia. In response to frost, urea solution can freeze so that a heating element is required to thaw urea solution as quickly as possible so that the urea required for the operation of the catalyst can be provided.

In the heating insert known from WO 2006/131201, an intake pipe and two electrical connecting lines are supported by a frame of a housing, in which PTC heating elements are arranged. The intake pipe is clipped into a groove comprising an Ω-shaped cross section, which supports said intake pipe across the greatest portion of its length. The advantage of the known heating insert is that the intake pipe can be fastened to the housing and to the frame of the heating element by pushing it into the groove with little effort and that urea solution can be thawed relatively quickly in the intake pipe by means of a good heat coupling to the frame and to the heated housing. It was shown, however, that a volume expansion arising in response to the freezing of urea solution can cause the intake pipe to detach from the housing, in particular when urea solution freezes in the intake pipe. In such a case, urea solution present in the intake pipe can be thawed only very poorly due to the reduced contact to the heated housing so that urea solution required for the operation of the catalyst can be provided only after a long thawing period.

It is thus the object of the invention to disclose a cost-efficient manner for reliably transferring a urea supply system for an exhaust gas cleaning catalyst of an internal combustion engine into an operational state in response to temperatures below the freezing point in a short period of time.

This object is solved by means of a heating insert comprising the features specified in claim 1. Advantageous embodiments of the invention are the object of the subclaims.

In the heating insert according to the invention, the intake pipe supports the at least one electrical connection. In so doing, the electrical connection can be used as a resistance heater for thawing urea solution contained in the intake pipe, even if a freezing of the urea solution has caused a deformation of the intake pipe. The intake pipe of a heating insert according to the invention can flexibly react to the expansion of the urea solution in response to the freezing and can bend without impacting its function.

The intake pipe of a heating insert according to the invention can be embodied so as to be flexible, for example by means of using a plastic comprising a Shore hardness of 60 to 80 Shore A so that it can be bent without problems for the installation of the heating insert into a urea tank and can be adapted to the shape of the urea tank.

The afore-mentioned object of the invention is furthermore solved by means of a urea supply system comprising the features specified in claim 21. In such a urea supply system, the return line is embodied in such a manner that urea solution escaping from the return line in response to the operation runs down the intake pipe. In so doing, the intake pipe can be heated additionally by means of already heated urea solution and can counteract the creation of an insulating air gap around the intake pipe and the housing.

Further details and advantages of the invention will be described by means of an exemplary embodiment with reference to the enclosed drawings. The features described therein can be made the object of claims individually and in combination. In the figures:

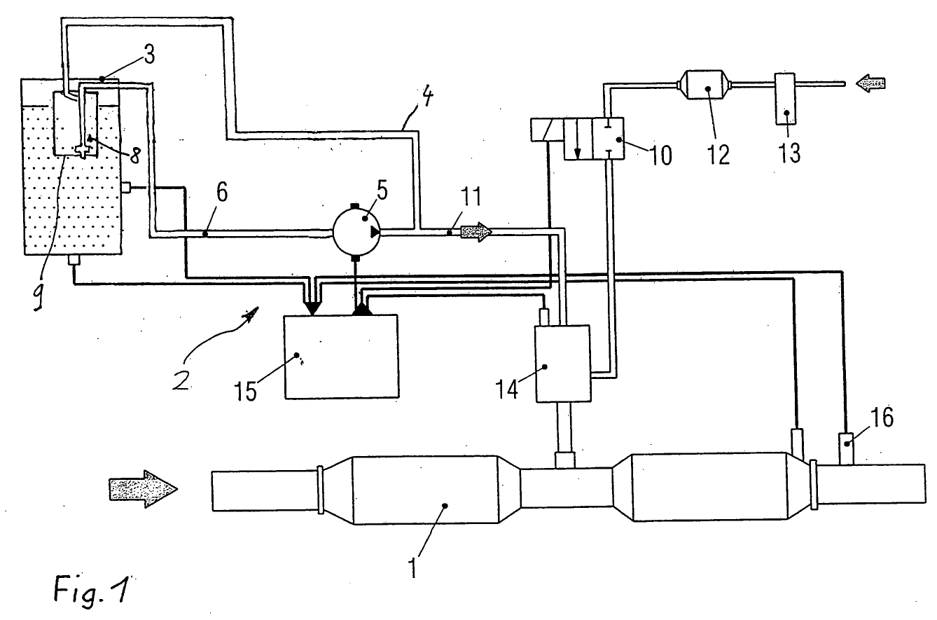

FIG. 1 shows a schematic illustration of a urea supply system according to the invention for an exhaust gas cleaning catalyst of a motor vehicle;

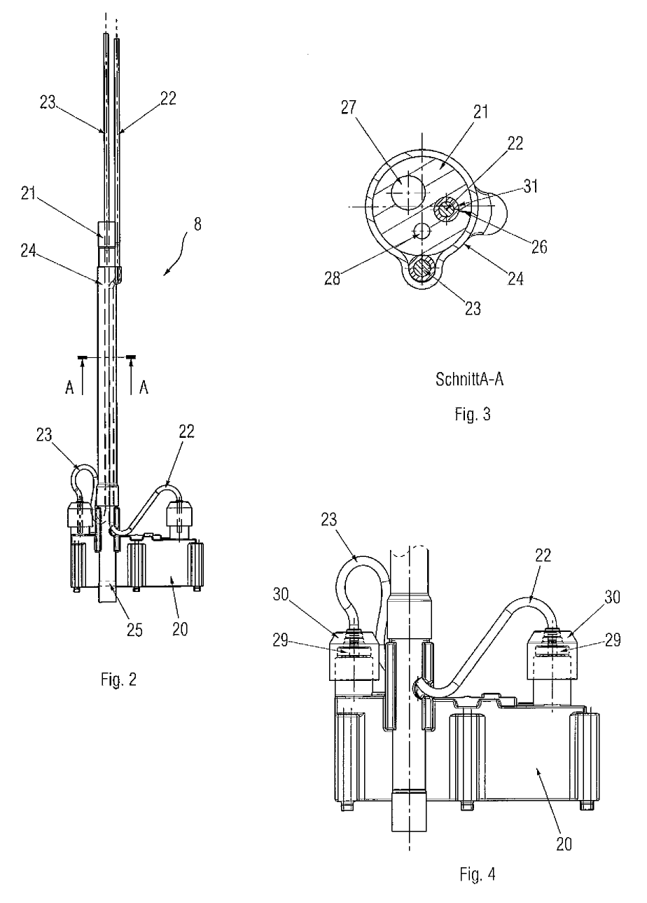

FIG. 2 shows a schematic illustration of an exemplary embodiment of a heating insert of the urea supply system shown in FIG. 1;

FIG. 3 shows a sectional view of the intake pipe along the intersection line AA of FIG. 2; and

FIG. 4 shows a schematic illustration of the seal of the electrical connecting lines at the heater housing.

FIG. 1 shows schematically an exhaust gas cleaning catalyst 1 of a motor vehicle and a corresponding urea supply system 2. In the exhaust gas cleaning catalyst 1, nitrogen oxides (NO, NO₂) are reduced to nitrogen by means of ammonia (NH₃). The ammonia required for this purpose is gained from a urea solution, which is provided by the urea supply system 2.

The urea supply system 2 illustrated in FIG. 1 comprises a urea tank 3 for accommodating urea solution, an interconnection 6, 11, which connects the urea tank 3 to the catalyst 1, a pump 5 for pumping urea through the interconnection 6, 11 from the urea tank 3 to the catalyst 1, and a heating insert 8 for heating the urea solution in the urea tank 3. The heating insert 8 has an intake pipe at the interconnection 11 for taking in urea solution. A return line 4, which leads into the urea tank 3, branches off from the interconnection 11 so that heated urea solution can be directed back into the urea tank 3.

The outlet of the return line 4 is embodied and arranged in such a manner that urea solution escaping from the return line during operation runs down the intake pipe of the heating insert 8. In so doing, the creation of an air gap between the heating insert 8 and urea solution ice, which is to be thawed, is counteracted and the intake pipe is heated additionally. Furthermore, the heating output of the intake pipe, which is then located in air, can be accommodated by the solution running down the intake pipe in response to a lower tank fill level and can be supplied to the fluid circulation.

In the illustrated exemplary embodiment, the heating insert 8 is arranged in a thawing container 9, which is connected to the return line 4 as well as to the interconnection 6 and which, in the illustrated exemplary embodiment, is arranged in the urea tank 3. The thawing container 9 has the effect that the heating output of the heating insert 8 can initially predominantly be used for heating the urea solution contained in the thawing container 9. The thawing container 9 has a capacity of approximately one liter and generally includes at least 0.2 to 0.3 liters of urea solution so that a sufficient amount of urea can be thawed in a sufficiently rapid manner for the operation of the exhaust gas cleaning catalyst 1. The thawing of the remaining urea solution can take place later without impacting the function of the urea supply system 2. The thawing container 9 has an exterior wall, which abuts on fluid in the urea tank 3. This measure has the advantage that heat is emitted into the urea tank 3 after the thawing of urea solution in the thawing container 9 and that the heating insert 8 can thus be used for the thawing container 9 as well as for the urea tank 3.

Urea solution can be sucked from the thawing container 9 as well as from the remaining portion of the urea tank 3 via the interconnection 6. This is so because the interconnection 6 is connected to an intake pipe, which extends into the urea tank 3 through the thawing container 9 and which is capable of sucking urea solution through an intake opening out of the thawing container 9 and through a second intake opening out of the urea tank. Details are illustrated in FIGS. 2 and 3 and will be defined later in context with these figures. The thawing container 9 has a non-illustrated overflow opening so that, in response to the suction of the urea solution via the second connection 7, the heat distribution, which is improved by means of the return line 4, can also be used for thawing the remaining urea solution, which is present outside of the thawing container 9.

The urea supply system 2 further comprises a control valve 10, which is connected to an air supply 12 comprising an air compressor 13, and a metering valve 14, with which urea solution and air can be supplied to the catalyst 1 in metered quantities. The pump 5, the valves 9, 10, 18 and the metering valve 14 are controlled by means of a control unit 15, to which data relating to the oxygen partial pressure in the catalyst 1 are supplied by a probe 16 and to which data relating to the urea temperature in the urea tank 3 are supplied by a temperature sensor. However, the urea solution can also be metered directly to the catalyst without using an air supply, in that the delivery pressure of the solution is used.

FIG. 2 illustrates an exemplary embodiment of a heating insert 8, which is suitable for the afore-described urea supply system 2. The heating insert 8 has a housing 20, in which at least one heating element is arranged. Preferably, a plurality of PTC heating elements, for example two, is arranged in the housing 20. An intake pipe 21 made of plastic is fastened to the housing 20. The intake pipe 21 serves the purpose of sucking fluid and is appropriately connected to a supply line. The intake pipe 21 is an elastic pipe, for example made of EPDM comprising a Shore hardness of 60 to 80 Shore A, which conducts heat well. The intake pipe is illustrated in FIG. 2 so as to be shortened. Preferably, its length is at least 10 cm, but can also be considerably longer and can for example be longer than 30 cm, in particular also longer than 50 cm.

The intake pipe 21 carries two electrical connecting lines 22, 23, which emanate from the housing 20 and which supply electricity to at least one heating element located therein. As a matter of principle, a single electrical connecting line 22 would be sufficient, if at least one heating element is connected to ground in a different manner. The connecting lines 22, 23 have a plastic jacket, which surrounds a heating resistance material, preferably a stainless steel, for example V2A or V4A steel. A heating of the connecting lines 22, 23 thus takes place during operation by means of ohmic resistance heating. The heat emitted by the connecting lines 22, 23 is emitted to the connecting pipe 21 and its direct environment so that ice present therein can be thawed quickly and a gap, via which a pressure compensation can take place in response to the sucking of fluid, can be thawed so as to be free. In the section supported by the intake pipe 21, the connecting lines 22, 23 in each case have a resistance of 0.3 Ω to 2.5 Ω per meter. Preferably, the resistance of the connecting lines 22, 23 is chosen in such a manner that each of the connecting lines 22, 23 during operation emits a heating power of 15 W to 40 W per meter of the length of the intake pipe 22, 23.

The optimal resistance of the connecting lines 22, 23 is a function of the vehicle voltage. With heating inserts 8 for passenger cars, the connecting lines 22, 23 in each case preferably have a resistance of 0.4 Ω to 0.6 Ω per meter; with heating inserts 8 for commercial vehicles (trucks), they have a resistance from 1.7 Ω to 2.5 Ω per meter.

The connecting lines 22, 23 can be embodied as simple wires. However, strands of wires are preferably used, because they have a greater flexibility than single wires with the same cross section as a strand of wires.

As is shown in FIG. 2, the intake pipe 21 has a section, which, emanating at the housing 20, extends in suction direction in a self-supporting manner and which supports the connecting lines 22, 23. A further section of the intake pipe 21 is supported by the housing 20. The supported section is placed into a groove of the housing 20, which preferably has an Q-shaped cross section. The self-supporting section of the intake pipe 21 is at least twice as long, preferably at least three times as long, as the supported section. It is thus attained that the intake pipe 21 can bend and that the orientation of the end of the intake pipe thereof, which faces in opposite direction to the suction direction, can change relative to the housing. This not only facilitates the installation of the heating insert 8 into a urea tank, but also has the effect that the intake pipe is not damaged by ice pressure, which occurs in response to the freezing of the fluid, and that it can withstand bending motions, caused by freezing fluids, without damage. It is particularly advantageous when the intake pipes 22, 23 run on a length of at least 10 cm, in particular at least 20 cm, preferably at least 30 cm, along the intake pipe 20 and when they are supported by said intake pipe 20.

In the illustrated exemplary embodiment, the connecting line 23 is arranged on the jacket surface of the intake pipe 21. The heat released by the connecting line 23 is thus mainly emitted to the abutting ice so that a duct along the intake pipe 21 can thus be freed from ice relatively quickly. The intake pipe 21 and the connecting line 23 arranged on its jacket surface are surrounded by a plastic casing 24, which presses the connecting line 23 against the intake pipe 21. Preferably, the plastic casing 24 is a shrink hose, because a particularly good heat coupling of the connecting line 23 to the intake pipe 21 can thus be attained and because heat generated by the connecting line 23, serving as an ohmic resistance heating element can also be emitted well to the intake pipe 21.

The further connecting line 22 is arranged in a duct of the intake pipe 21, which, in the simplest case, can be embodied as a groove. Preferably, the further connecting line 22 in the duct is enclosed all around, wherein the intake pipe encompasses a further duct for supplying the fluid. This leads to a particularly good heat coupling of the connecting line 22 to the intake pipe 21. The jacket surface of the intake pipe 21 can be scratched, thus creating a slit, into which the connecting line is placed for the purpose of embodying the duct for the connecting line 22 or for opening an already existing duct, so that the connecting line 22 can be more easily placed into the duct.

The rims of the slot created in such a manner close automatically after the placement of the connecting line 22 in response to the use of an elastomeric plastic so that the intake pipe 21 encompasses a joint, which extends in longitudinal direction, behind which the duct comprising the connecting line 22 runs. The joint can additionally be closed by means of a material connection, for example by means of welding. For embodying the described duct for the connecting line 22, the intake pipe 21 is scratched only to the extent so as not to generate an opening to the duct for supplying the fluid. In the illustrated exemplary embodiment, the two connecting lines 22, 23 run free of twists, thus substantially linearly, in longitudinal direction of the intake pipe 21.

Instead of creating a slot by means of scratching the jacket surface of the intake pipe 21, the intake pipe can also be manufactured with an open jacket surface, into which a connecting line can be placed, for example by means of extrusion.

In the illustrated exemplary embodiment, the intake pipe 21 does not only include one but two separate ducts for supplying fluid in addition to the duct for the connecting line 22. This is so because the intake pipe 20 projects with its intake end beyond the housing 20 of the heating insert 8. If the illustrated heating insert 8 is installed in a thawing container 9, which is arranged in a urea tank 3, as is illustrated in FIG. 1, the intake pipe 20 appropriately projects with its intake end through an opening of the thawing container 9 (not illustrated) and into the urea tank 3. As is shown in FIG. 2, an intake opening 25, through which the fluid can be sucked into one of the two ducts for supplying the fluid, is located in a jacket surface of the intake pipe 20. The second duct for supplying the fluid has an intake opening at the end of the intake pipe 21, which appropriately projects into the urea tank 3.

FIG. 3 shows in a schematic view a sectional view along the intersection line AA through the intake pipe 21, which is plotted in FIG. 2. It can be seen therein that the intake pipe 21 includes three separate ducts. The connecting line 22 arranged therein and the joint 26, which closes the respective duct 31, is illustrated in one of these ducts 31. The two ducts 27, 28 for supplying the fluid are also shown in FIG. 3. The duct 28 is closed at the intake end of the intake pipe 21, because fluid can reach into this duct through the intake opening 25 illustrated in FIG. 2. In response to an appropriate installation, a fluid can be sucked out of the urea tank 3 by means of the opening the duct 27.

The intake opening 25 is located at least 1 cm, preferably several cm away from the intake end of the intake pipe 21. If the heating insert 8 is appropriately arranged in a thawing container 9, fluid can be sucked from the thawing container through the intake opening 25 and fluid can be sucked from a urea tank 3 by means of the intake opening 27 of the second fluid supply duct. If the fluid is frozen in the urea tank, a fluid is thus automatically supplied from the thawing container 9.

A defined flow ratio for the fluid supply can be established in a simple manner by selecting the cross sectional ratios of the two fluid supply ducts 27, 28 of the intake pipe 21.

The housing 20 of the heating insert 8 is a metal housing, which has a plastic jacket, which protects it from corrosive urea solution. The connecting lines 22, 23, which emanate from the housing 20, form potential leakage points, via which the fluid can penetrate into the housing 20. In the illustrated exemplary embodiment, the housing 20 is thus sealed against the penetration of fluid by means of seals, which surround the connecting lines 22, 23.

FIG. 4 shows schematically the sealing of the housing 20 and the connecting lines 22, 23. The connecting lines 22, 23 are in each case surrounded by a seal 29, which is a formed plastic part, which is slid onto the connecting lines 22, 23.

As is shown in FIG. 4, the formed plastic part 29, which forms the seal, carries a plastic cap 30, which is also slid onto the connecting lines 22, 23. The formed plastic part 29 has a conical section, by means of which it surrounds the connecting line 22, 23 and a wider bottom ring. The conical section has a tapering end, which points away from the housing 20 and which is surrounded by the plastic cap 30. In response to the assembly, the plastic cap 30 is pressed onto the formed plastic part 29 so that, due to the conical section, it is pressed against the plastic jacket of the connecting lines 22, 23 so as to form a seal. In so doing, the formed plastic part 29 surrounds the respective connecting lines 22, 23 with a section, which is surrounded by the plastic cap 30, wherein the contact pressure exerted by the plastic cap 30 increases along the connecting line 22, 23 towards the housing 20. This can also be attained in that the plastic cap 30 has an interior, which has an interior, which narrows in a truncated manner and into which the formed plastic part comprising a cylindrical section or a less highly tapering section is pressed.

The bottom ring seals against the housing 20. Once the plastic cap 30 has reached the position illustrated in FIG. 4 in response to the assembly, the plastic cap 30 is connected to the plastic jacket of the housing 20 by means of a material connection, preferably by means of welding. A reliable seal can be effected in particular by welding the plastic jacket 20 to the plastic cap 30.

### REFERENCE NUMERALS

1 exhaust gas cleaning catalyst
2 urea supply system
3 urea tank
4 return line
5 pump
6 interconnection
7 connection of the interconnection 6
8 heating insert
9 thawing container
10 control valve
11 interconnection
12 air supply
13 air compressor
14 metering valve
15 control unit
16 probe
18 valve
20 housing
21 intake pipe
22 electrical connecting line
23 electrical connecting line
24 plastic casing
25 intake opening
26 joint
27 fluid supply duct of the intake pipe
28 fluid supply duct of the intake pipe
29 formed plastic part
30 plastic cap
31 fluid supply duct of the intake pipe

1. A heating insert for thawing a fluid comprising at least one heating element, which is arranged in a housing (20),
an intake pipe (21) made of plastic, which is fastened to the housing (20), for dipping into the fluid,
at least one electrical connecting line (22, 23), which emanates from the housing (20) and which runs along the intake pipe (21),
characterized in that the intake pipe (21) supports the at least one connecting line (22, 23).

2. The heating insert according to claim 1, characterized in that the intake pipe (21) includes a section, which, emanating from the housing (20), extends in suction direction in a self-supporting manner and which supports the at least one connecting line (22, 23).

3. The heating insert according to claim 2, characterized in that the intake pipe (21) includes a further section, which is supported by the housing (20), the self-supporting section being at least twice as long, preferably at least three times as long, as the supported section.

4. The heating insert according to any one of the preceding claims, characterized in that the intake pipe (21) includes a duct (27, 28) for supplying the fluid and a further duct (31), in which the at least one connecting line (22) is arranged.

5. The heating insert according to claim 4, characterized in that the intake pipe (21) includes a joint (26), behind which the further duct (31) comprising the at least one connecting line (22) runs.

6. The heating insert according to any one of the preceding claims, characterized in that the at least one connecting line (22, 23) is arranged on a jacket surface of the intake pipe (21).

7. The heating insert according to claim 4 and 6, characterized in that a first connecting line (22) is arranged in the further duct (31) and in that a second connecting line (23) is arranged on the jacket surface of the intake pipe (21).

8. The heating insert according to any one of the preceding claims, characterized in that the intake pipe (21) is surrounded by a plastic sleeve (24).

9. The heating insert according to claim 8, characterized in that the plastic sleeve (24) is a shrink hose.

10. The heating insert according to any one of the preceding claims, characterized in that the at least one connecting line (22, 23) is a strand.

11. The heating insert according to any one of the preceding claims, characterized in that the at least one connecting line (22, 23) is made of a heating resistance material, preferably of a stainless steel.

12. The heating insert according to any one of the preceding claims, characterized in that the at least one connecting line (22, 23) has an electrical resistance of 0.3 Ω per meter to 2.5 Ω per meter.

13. The heating insert according to any one of the preceding claims, characterized in that the at least one connecting line (22, 23) is surrounded by a plastic jacket.

14. The heating insert according to any one of the preceding claims, characterized in that the housing (20) is a metal housing comprising a plastic jacket.

15. The heating insert according to any one of the preceding claims, characterized in that the housing (20) is sealed against the penetration of fluid by means of a seal (29), which surrounds the at least one connecting line (22, 23), wherein the seal (29) is a formed plastic part, which is slid onto the connecting line (22, 23).

16. The heating insert according to claim 15, characterized in that the formed plastic part (29) carries a plastic cap (30).

17. The heating insert according to claim 14 and 16, characterized in that the plastic cap (30) is welded to the plastic jacket of the housing (20).

18. The heating insert according to claim 16 or 17, characterized in that the formed plastic part (29) surrounds the at least one connecting line (22, 23) with a section, which is surrounded by the plastic cap (30), wherein the contact pressure exerted by the plastic cap (30) increases along the connecting line (22, 23) towards the housing (20).

19. The heating insert according to any one of claims 16 to 18, characterized in that the formed plastic part (29) surrounds the at least one connecting line (22, 23) with a conical section, which includes a tapering end, which points away from the housing (20) and which is surrounded by the plastic cap (30).

20. The heating insert according to any one of the preceding claims, characterized in that the at least one connecting line (22, 23) runs free of twists in longitudinal direction of the intake pipe (21).

21. A urea supply system for an exhaust gas cleaning catalyst (1) of an internal combustion engine, in particular of a motor vehicle, comprising
a urea tank (3) for accommodating a urea solution,
a heating insert (8) according to any one of the preceding claims for thawing a frozen urea solution,
a connecting line (6, 11), which connects the intake pipe (21) of the heating insert (8) to the exhaust gas cleaning catalyst (1),
a pump (5) for pumping urea solution through the interconnection (6, 11) from the urea tank (3) to the catalyst (1) and
a return line (4), which branches of from the interconnection (22, 23) and which leads to the urea tank (3), characterized in that
the return line (4) is embodied and arranged in such a manner that urea solution escaping from the return line (4) during operation runs down the intake pipe (21).
